(19) United States
(12) Patent Application Publication
(10) Pub. No.: US 2022/0057360 A1
(43) Pub. Date: Feb. 24, 2022

(54) SEPARATION CAPILLARY INKJET DISPENSING WITH FLAT PIEZOELECTRIC ACTUATOR

(71) Applicant: LI-COR, Inc., Lincoln, NE (US)

(72) Inventors: Michael D. Furtaw, Lincoln, NE (US); Donald T. Lamb, Lincolin, NE (US)

(73) Assignee: LI-COR, Inc., Lincoln, NE (US)

(21) Appl. No.: 17/518,430

(22) Filed: Nov. 3, 2021

Related U.S. Application Data
(63) Continuation-in-part of application No. 16/860,514, filed on Apr. 28, 2020.
Application No. 16/860,514 is a division of application No. 15/420,496, filed on Jan. 31, 2017, now Pat. No. 10,670,560.
(60) Provisional application No. 63/121,170, filed on Dec. 3, 2020.
(60) Provisional application No. 62/289,691, filed on Feb. 1, 2016.

(51) Int. Cl. G01N 27/447

(52) U.S. Cl. CPC G01N 27/44739; G01N 27/44791

(57) ABSTRACT

A flat bar piezoelectric actuator affixed to a pressure chamber with one or more separation capillary tubes exiting near respective nozzle orifices is disclosed. The flat actuator against a flat wall of the pump chamber causes a relatively planar pressure wave to pass by the end of each capillary, transporting a precise amount of separated analyte from the capillary out of the nozzle orifice. The nozzle may or may not be tapered. Multiple nozzles can form an inkjet print head that ejects precise droplets of analyte and sheath fluid. The small volume of mixed sheath liquid and analyte can then be jetted through the nozzle at a moving surface, either continuously or as discrete droplets. Relative positions on the surface can indicate separation distances of dispensed analytes.

### CROSS-REFERENCES TO RELATED APPLICATIONS

This application claims the benefit of U.S. Provisional Patent Application No. 63/121,170, filed Dec. 3, 2020, and is a continuation-in-part of U.S. patent application Ser. No. 16/860,514, filed Apr. 28, 2020, which is a divisional application of U.S. patent application Ser. No. 15/420,496, filed Jan. 31, 2017, which claims the benefit of U.S. Provisional Application No. 62/289,691, filed Feb. 1, 2016. These applications are hereby incorporated by reference in their entireties for all purposes.

### STATEMENT AS TO RIGHTS TO INVENTIONS MADE UNDER FEDERALLY SPONSORED RESEARCH AND DEVELOPMENT

This invention was made with government support under 1R43GM112289-01 awarded by the National Institutes of Health and National Institute of General Medical Studies. The government has certain rights in the invention.

### BACKGROUND

### 1. Field of the Invention

The present application generally relates to systems for the investigation or analysis of samples using electrophoresis by depositing to a membrane. Specifically, the application is related to a capillary electrophoresis blotting system using a sheath liquid propelled by flat bar piezoelectric actuators.

### 2. Description of the Related Art

Western blotting is a ubiquitous analytical technique for identifying and quantifying specific proteins in a complex mixture. In the technique, gel electrophoresis is used to separate proteins in a gel based on properties such as tertiary structure, molecular weight, isoelectric point, polypeptide length, or electrical charge. Once separated, the proteins are then transferred from the gel to a membrane—typically made of nitrocellulose, nylon, or polyvinylidene fluoride (PVDF)—that binds proteins non-specifically. A commonly used method for carrying out this transfer is electroblotting, in which an electrical current is used to pull proteins from the gel into the membrane. The membrane is then stained with probes specific for the proteins being targeted, allowing the location and amounts of these proteins to be detected.

Capillary electrophoresis provides an alternative to the gel electrophoresis separation associated with Western blotting and other biotechnology procedures. In capillary electrophoresis, materials such as proteins are separated electrokinetically, as in gel electrophoresis, but with much smaller required volumes. The capillaries used in this technique are typified by diameters smaller than one millimeter and are in some instances incorporated into microfluidic or nanofluidic devices.

There exists in the art a need to improve and advance the technique of Western blotting, as well as other membrane analysis methods such as Northern blotting and Southern blotting. The numerous steps involved with these methods makes them relatively time-consuming, labor-intensive, and prone to errors or variability.

### BRIEF SUMMARY

In general, provided herein are devices and methods for the dispensing of small, controllable amounts of material that have been separated by capillary electrophoresis.

The end of a capillary electrophoresis tube exits into a nozzle that is connected with a pump chamber for sheath fluid. The pump chamber has a flat wall. Against the outside of the flat wall is a bar-shaped piezoelectric actuator. When the piezoelectric material actuates, an inner surface of the flat wall is momentarily pushed in or pulled out and deformed. The deformation intentionally creates an acoustic wave that travels within the pump chamber. Under certain conditions the acoustic wave provides enough energy to eject a single droplet from the nozzle outlet orifice. Repeated ejections of droplets create a flow of sheath fluid downstream, around the capillary's exit, drawing separated analyte with it. As the capillary exit is very near the nozzle outlet orifice, the small portion of analyte from the capillary tube and sheath fluid have very little opportunity to mix before being spewed from the nozzle outlet. The resulting droplet exits the nozzle at high speed to be deposited on a moving membrane.

Multiple nozzles can be aligned in a row, the outlet of each nozzle, and/or the outlet of each capillary tube within each nozzle, no closer to the deforming wall thanks to the elongated bar shaped actuator spanning across the other side of the wall. That is, the piezoelectric bar stretches laterally behind the nozzles so that when it pulses, the deformation is spread over an internal wall to cause relatively equal pressure waves among the capillaries and nozzles to jettison the analytes.

In some embodiments, a capillary electrophoresis tube is positioned such that a portion of the tube proximate to the tube outlet is within a microfluidic pump chamber. The outlet of the capillary electrophoresis tube is positioned within a microfluidic nozzle that is in fluidic connection to the microfluidic pump chamber. The microfluidic pump and microfluidic nozzle hold a sheath fluid that enters the pump through a sheath flow tube that is connected to the pump inlet. An impulsive pump element is mechanically connected to the microfluidic pump and electrically connected to an impulsive pump actuator, such that expansion and/or contraction of the pump element in response to electrical signals from the pump actuator causes deformation of at least a portion of the pump chamber. This deformation causes some of the sheath fluid to be expelled out of the microfluidic chamber through a nozzle outlet of the microfluidic nozzle.

The deformation can be so small that it does not directly push the fluid out. That is, if one deformed the chamber with the same amplitude but at a slower speed—nothing would exit the device. The deformation creates an acoustic wave that, under the right conditions, has enough energy to expel a small droplet at the nozzle orifice.

As separated material exits the capillary electrophoresis tube, it mixes with the sheath fluid located proximate to the capillary outlet. As the sheath fluid is expelled through the microfluidic nozzle outlet, it entrains the separated material, resulting in a mixture dispensed in the form of discrete droplets, a semi-continuous stream, or a continuous stream. The resolution of dispensed separated material can be maintained by decreasing the mixing volume and the amount of time that the separated material is exposed to in the microfluidic nozzle after eluting from the capillary electrophoresis tube. One approach for decreasing this volume is to taper one or both of the microfluidic nozzle and capillary electrophoresis tube proximate to their respective outlets. Another approach is to decrease the distance between the capillary electrophoresis tube outlet and the microfluidic nozzle outlet. Another approach is to orient the capillary electrophoresis tube within the microfluidic nozzle such that the outlet is substantially pointed in the direction of the microfluidic nozzle outlet.

One provided apparatus comprises a capillary electrophoresis tube that has a capillary inlet, a capillary outlet, and a capillary longitudinal axis proximate to the capillary outlet. In some embodiments, a separation buffer is within the capillary electrophoresis tube. In some embodiments, the capillary electrophoresis tube is at least partially filled with a sieving matrix. A first electrode is proximate to and in fluidic connection with the capillary inlet, and a second electrode is proximate to and in fluid connection with the capillary outlet. The apparatus further comprises a microfluidic pump chamber that has an internal region and a pump inlet, wherein the microfluidic pump chamber is connected to an impulsive pump element. The apparatus further comprises a microfluidic nozzle having a nozzle outlet, a tapered internal region proximate to the nozzle outlet, and a nozzle longitudinal axis proximate to the nozzle outlet. The microfluidic nozzle is in fluid connection with the microfluidic pump chamber, wherein the capillary outlet of the capillary electrophoresis tube is located within the tapered internal region of the microfluidic nozzle.

In some embodiments, the capillary outlet terminates between about 5 μm and about 500 μm from the nozzle outlet. In some embodiments, the diameter of the nozzle outlet is between about 5 μm about 200 μm.

In some embodiments, the capillary electrophoresis tube extends through the pump inlet of the microfluidic pump chamber to the tapered internal region of the microfluidic nozzle. In some embodiments, the capillary longitudinal axis of the capillary electrophoresis tube is parallel to the longitudinal axis of the microfluidic nozzle. In some embodiments, the capillary longitudinal axis of the capillary electrophoresis tube extends through the nozzle outlet of the microfluidic nozzle. In some embodiments, the capillary longitudinal axis of the capillary electrophoresis tube is coaxial with the nozzle longitudinal axis of the microfluidic nozzle.

In some embodiments, the capillary electrophoresis tube further comprises a capillary electrophoresis tube tapered region proximate to the capillary outlet. In some embodiments, the apparatus further comprises a spacer configured to create a void space between the capillary electrophoresis tube tapered region and the tapered internal region of the microfluidic nozzle. In some embodiments, the spacer is integrally formed with the capillary electrophoresis tube. In some embodiments, the spacer is integrally formed with the microfluidic nozzle.

In some embodiments, the apparatus further comprises a non-conducting polymer shell surrounding the microfluidic pump chamber and the impulsive pump element. In some embodiments, the apparatus further comprises a metal shell surrounding the microfluidic pump chamber and the impulsive pump element. In some embodiments, the second electrode is connected with the metal shell.

In some embodiments, the apparatus further comprises a sheath flow tube connected with the pump inlet. In some embodiments, the sheath flow tube is in fluidic connection with a sheath flow reservoir. In some embodiments, the second electrode is located within the sheath flow reservoir.

In some embodiments, the apparatus further comprises an analyte within the capillary electrophoresis tube, and a sheath liquid within the microfluidic pump chamber.

In some embodiments, the impulsive pump element comprises a piezoelectric material or a thermoresistive material.

Also provided is an apparatus comprising a capillary electrophoresis tube that has a capillary inlet, a capillary outlet, and a capillary longitudinal axis proximate to the capillary outlet. In some embodiments, a separation buffer is within the capillary electrophoresis tube. In some embodiments, the capillary electrophoresis tube is at least partially filled with a sieving matrix. A first electrode is proximate to and in fluidic connection with the capillary inlet, and a second electrode is proximate to and in fluid connection with the capillary outlet. The apparatus further comprises a microfluidic pump chamber that has an internal region and a pump inlet, wherein the microfluidic pump chamber is connected to an impulsive pump element. The apparatus further comprises a microfluidic nozzle having a nozzle outlet and a nozzle longitudinal axis proximate to the nozzle outlet. The microfluidic nozzle is in fluid connection with the microfluidic pump chamber, wherein the capillary outlet of the capillary electrophoresis tube is located within an internal region of the microfluidic nozzle proximate to the nozzle outlet.

In some embodiments, the capillary outlet terminates between about 5 μm and about 500 μm from the nozzle outlet. In some embodiments, the diameter of the nozzle outlet is between about 5 μm and about 200 μm.

In some embodiments, the capillary longitudinal axis of the capillary electrophoresis tube is parallel to the longitudinal axis of the microfluidic nozzle. In some embodiments, the capillary longitudinal axis of the capillary electrophoresis tube extends through the nozzle outlet of the microfluidic nozzle. In some embodiments, the capillary longitudinal axis of the capillary electrophoresis tube is coaxial with the nozzle longitudinal axis of the microfluidic nozzle.

In some embodiments, the apparatus further comprises a non-conductive polymer shell surrounding the microfluidic pump chamber and the impulsive pump element. In some embodiments, the apparatus further comprises a metal shell surrounding the microfluidic pump chamber and the impulsive pump element. In some embodiments, the second electrode is connected with the metal shell.

In some embodiments, the apparatus further comprises a sheath flow tube connected with the pump inlet. In some embodiments, the sheath flow tube is in fluidic connection with a sheath flow reservoir. In some embodiments, the second electrode is located within the sheath flow reservoir.

In some embodiments, the apparatus further comprises an analyte within the capillary electrophoresis tube, and a sheath liquid within the microfluidic pump chamber.

In some embodiments, the impulsive pump element comprises a piezoelectric material or a thermoresistive material.

Also provided is a method for dispensing an analyte from a capillary electrophoresis tube. The method comprises applying a voltage potential through a capillary electrophoresis tube that has a capillary outlet, and a capillary longitudinal axis proximate to the capillary outlet. In some embodiments, a separation buffer is within the capillary electrophoresis tube. In some embodiments, the capillary electrophoresis tube is at least partially filled with a sieving matrix. The method further comprises impulsively pumping a sheath liquid through a microfluidic pump chamber in fluidic connection with a microfluidic nozzle. The microfluidic nozzle has a nozzle outlet, a tapered internal region proximate to the nozzle outlet, and a nozzle longitudinal axis proximate to the nozzle outlet. The capillary outlet of the capillary electrophoresis tube is located within the tapered internal region of the microfluidic nozzle. The method further comprises mixing a separated analyte with the sheath liquid, wherein the separated analyte exits the capillary electrophoresis tube through the capillary outlet. The mixing of the separated analyte and the sheath liquid is substantially entirely within the tapered internal region of the microfluidic nozzle. The method further comprises dispensing the mixture of the separated analyte and the sheath liquid through the nozzle outlet of the microfluidic nozzle.

In some embodiments, the method further comprises controlling the pressure of the sheath liquid in a sheath liquid reservoir that is in fluidic connection with the microfluidic pump chamber. In some embodiments, the method further comprises controlling the pressure of a capillary electrophoresis solution in a capillary electrophoresis solution reservoir that is in fluidic connection with the capillary outlet.

In some embodiments, the method further comprises flowing a capillary electrophoresis solution through the capillary electrophoresis tube and out of the capillary outlet, wherein the flowing is subsequent to applying the voltage potential.

In some embodiments, the capillary longitudinal axis of the capillary electrophoresis tube is parallel to the longitudinal axis of the microfluidic nozzle. In some embodiments, the capillary longitudinal axis of the capillary electrophoresis tube extends through the nozzle outlet of the microfluidic nozzle. In some embodiments, the capillary longitudinal axis of the capillary electrophoresis tube is coaxial with the nozzle longitudinal axis of the microfluidic nozzle.

In some embodiments, the dispensing of the mixture out of the nozzle outlet creates one or more droplets. In some embodiments, the dispensing of the mixture out of the nozzle outlet creates a stream.

In some embodiments, the dispensing step further comprises contacting the dispensed mixture with a surface. In some embodiments, the surface comprises a hydrophobic material. In some embodiments, the surface comprises a hydrophilic material. In some embodiments, the surface is a blotting membrane. In some embodiments, the method further comprises controlling the position of the surface relative to that of the microfluidic nozzle.

### BRIEF DESCRIPTION OF THE DRAWINGS

FIG. 1 illustrates one embodiment of a capillary electrophoresis dispensing apparatus.

FIG. 2 illustrates a system in accordance with one embodiment of a capillary electrophoresis dispensing apparatus.

FIG. 3 is a close-up illustration of the tapered internal region of the microfluidic nozzle of the dispensing apparatus, showing one embodiment in which the capillary longitudinal axis of the capillary electrophoresis tube is parallel to the nozzle longitudinal axis of the microfluidic nozzle.

FIG. 4 is a close-up illustration of the tapered internal region of the microfluidic nozzle of the dispensing apparatus, showing one embodiment in which the capillary longitudinal axis of the capillary electrophoresis tube is coaxial with the nozzle longitudinal axis of the microfluidic nozzle.

FIG. 5 is a close-up illustration of the tapered internal region of the microfluidic nozzle of the dispensing apparatus, showing one embodiment in which the capillary longitudinal axis of the capillary electrophoresis tube extends through the nozzle outlet of the microfluidic nozzle.

FIG. 6 is a close-up illustration of the tapered internal region of the microfluidic nozzle of the dispensing apparatus, showing one embodiment in which the capillary outlet of the capillary electrophoresis tube is located within the tapered internal region of the microfluidic nozzle.

FIG. 7 is a stroboscopic image showing successful droplet dispensing with a capillary located concentrically within a piezoelectric inkjet dispenser.

FIG. 8 is a close-up illustration of the tapered internal region of the microfluidic nozzle of the dispensing apparatus, showing one embodiment in which the capillary outlet of the capillary electrophoresis tube is located within the tapered internal region of the microfluidic nozzle, and the capillary electrophoresis tube comprises a capillary tapered region proximate to the capillary outlet.

FIG. 9 is a stroboscopic image showing successful droplet dispensing with a tapered capillary located concentrically within a piezoelectric inkjet dispenser.

FIG. 10 is a graph of the predicted output signals of capillary inkjet dispensers using standard and tapered capillaries.

FIG. 11 is an image of triplicate traces created by dispensing 100 drops/second onto a nitrocellulose membrane moving at 5, 2, 1, and 0.5 mm/second.

FIG. 12 is an image of triplicate traces created by dispensing drops onto a nitrocellulose membrane, a nitrocellulose on glass membrane, and a ZETA-GRIP™ hydrophobic membrane.

FIG. 13 is a graph of calculated spot diameters versus substrate contact angles for dispensed drops of various volumes.

FIG. 14 illustrates one embodiment of a capillary electrophoresis dispensing system with an array of four dispensing units used to dispense material onto a membrane surface connected to a support surface.

FIG. 15 is a flowchart of a process in accordance with an embodiment.

FIG. 16 illustrates a cross-section of a flat actuator working with a single capillary in accordance with an embodiment.

FIG. 17A is a top isometric view of a flat actuator device working with multiple capillaries in accordance with an embodiment.

FIG. 17B is a bottom isometric view of the device of FIG. 17A.

FIG. 17C is a vertical cross-section of the device of FIG. 17A.

FIG. 17D is bottom view of the device of FIG. 17A.

FIG. 18 illustrates a cross-section of a flat actuator against a back wall of a pump chamber in which a capillary exits perpendicularly to a nozzle in accordance with an embodiment.

FIG. 19A is a top isometric view of a flat actuator device with multiple capillaries exiting perpendicularly to their respective nozzles in accordance with an embodiment.

FIG. 19B is a bottom isometric view of the device of FIG. 19A.

FIG. 19C is a vertical cross-section of the device of FIG. 19A.

### DETAILED DESCRIPTION

Embodiments of the present invention include devices and methods for dispensing material output from a capillary electrophoresis tube. The inventors have assembled a new configuration for a dispensing device that can be used to deliver at high resolution material eluted from a separation channel.

A technical advantage of some embodiments is the enabling of high spatial resolution blotting of separated molecules onto a solid support. The devices and methods described herein can operate with a wide variety of dispensed droplet sizes (e.g., 10 picoliter-10 nanoliter) and frequencies (e.g., 0-10,000 Hz). The dispensing largely does not fragment or otherwise damage biomolecules during the process.

A technical advantage of some embodiments is that the separation column associated with the dispensing device can be physically isolated from a solid support that material is dispensed onto. Because of this separation, no fluid or electrical connection is required between the dispensing device and the solid support. As a result, the solid support has no required electrical properties and can comprise an insulating, conducting, and/or non-conducting material.

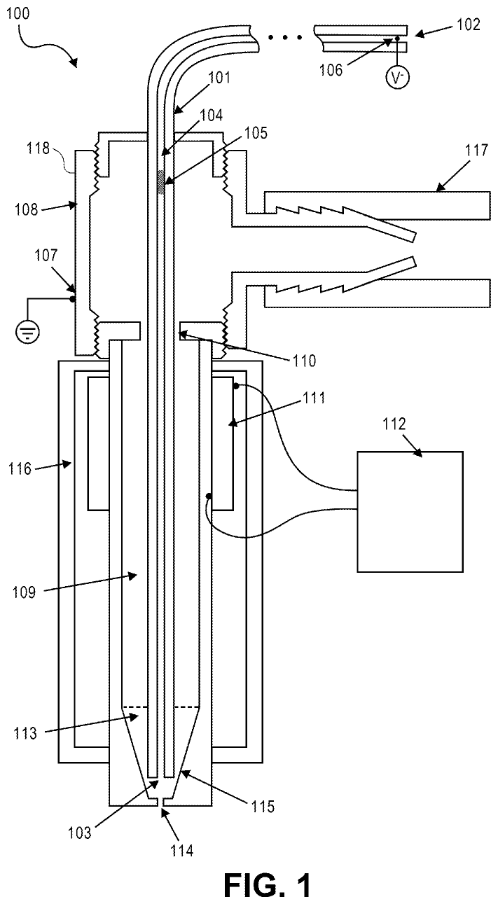

FIG. 1 illustrates one embodiment. Shown in device 100 is a capillary electrophoresis tube 101 having a capillary inlet 102 and a capillary outlet 103. The interior 104 of the capillary electrophoresis tube can be filled with a separation buffer 105. A first electrode 106 is proximate to and in fluid connection with the capillary inlet 102. A second electrode 107 is connected to an electrically conductive material 108 that is in fluid connection with the capillary outlet 103.

“Fluid connection” refers to a mechanical or physical connection between two or more elements that provides for the transfer between the elements of a flowing substance when present. The flowing substance can be, for example, a gas or liquid material, mixture, solution, dispersion, or suspension. The flowing substance is not required for the fluid connection to exist. In some aspects, an apparatus having a fluid connection can be provided to a user without the flowing substance or fluid, and the fluid can then be separately provided or introduced into the apparatus by the user.

Also provided is a microfluidic pump chamber 109 having a pump inlet 110. The microfluidic pump chamber 109 is connected to an impulsive pump element 111 that is electrically connected to a pump actuator 112. The microfluidic pump chamber 109 is also in fluid connection with a microfluidic nozzle 113 having a nozzle outlet 114.

In some embodiments, and as is shown in FIG. 1, the microfluidic nozzle further comprises a tapered internal region 115 that is proximate to the nozzle outlet. In some embodiments, and as is shown in FIG. 1, the capillary outlet 103 of the capillary electrophoresis tube 101 is located within the tapered internal region 115 of the microfluidic nozzle.

In some embodiments, the electrically conductive material 108 that the second electrode 107 is connected to is a T fitting. In some embodiments, the second electrode 107 is instead connected to an electrically conductive shell 116 that surrounds the microfluidic pump chamber 109 and the impulsive pump element 111.

The shell and/or T fitting can comprise a metal, such as silver, copper, gold, aluminum, molybdenum, zinc, lithium, brass, nickel, iron, tungsten, palladium, platinum, tin, or bronze. In some embodiments, the second electrode 107 is itself proximate to and in fluid connection with the capillary outlet 103.

In some embodiments, the shell 116 that surrounds the microfluidic pump chamber 109 and the impulsive pump element 111 can be a non-conducting, inert, or electrically insulating material. In some embodiments, the shell can be a polymeric material that is non-conducting, inert, or electrically insulating. In some embodiments, the shell can be treated with a coating that is non-conducting, inert, or electrically insulating.

Also provided is a sheath flow tube 117 that is in fluid connection with the pump inlet 110 of the microfluidic pump chamber 109. Sheath liquid can travel through the sheath flow tube 117 and the pump inlet 110 into the microfluidic pump chamber 109 and microfluidic nozzle 113. Sheath liquid supplied through this sheath flow tube can replace sheath liquid that has exited the microfluidic pump through the microfluidic nozzle outlet. The connection of the sheath flow tube and the pump inlet can be through a T fitting 118.

The microfluidic pump can contain a sheath liquid that surrounds the outlet portion of the capillary electrophoresis tube. In some embodiments, the sheath liquid comprises one or more aqueous liquids, one or more organic liquids, or a mixture of these. The pump can act to pressurize the sheath liquid, causing it to exit the pump through the nozzle outlet of the connected microfluidic nozzle. As it exits the microfluidic nozzle outlet, the sheath liquid can entrain material that is output from the capillary electrophoresis tube.

The liquid that exits the microfluidic nozzle can consist entirely of sheath liquid. The liquid that exits the microfluidic nozzle can consist entirely of material that is output from the capillary electrophoresis tube. The material that is output from the capillary electrophoresis tube can include one or more of a capillary electrophoresis tube solution, a buffer, a sieving matrix, a sample, or one or more analytes. In some embodiments, the liquid that exits the microfluidic nozzle comprises a mixture of sheath liquid and material that is output from the capillary electrophoresis tube, wherein the percentage of the mixture that comprises sheath liquid is about 0%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%.

The sieving matrix of the capillary electrophoresis tube, when optionally present, can comprise nanoparticles, beads, macromolecules, a colloidal crystal, a gel, a polymer solution, or one or more other media. Examples of gels suitable for use in a sieving matrix include those comprising acrylamide or agarose. The sieving gel can include, for example, one or more of sodium dodecyl sulfate (SDS), polyvinylpyrrolidone (PVP), polyethylene oxide (PEO), polylactic acid (PLA), polyethylene glycol (PEG), polydimethylacrylamide (PDMA), acrylamide, polyacrylamide, methylcellulose, hydroxypropylmethyl cellulose (HPMC), hydroxypropyl cellulose (HPC), hydroxyethyl cellulose (HEC), agarose gel, or dextran.

Protein and DNA size-based separation techniques often rely on gels or polymer solutions to resolve populations of biomolecules. These gels and polymer solutions create a random sieving media through which the biomolecules migrate, separating the molecules by size as they pass through the media. The composition and porosity of conventional separation media can be modified to produce pores of different average sizes within the media. The sieving matrix can contain a substantially heterogeneous or substantially homogeneous assortment of pore sizes.

The sieving matrix, when optionally present, can include silica nanoparticles that form a colloidal crystal, providing a separation media which has a substantially monodisperse pore size, based on the monodispersity of the silica colloid size and the crystallization of the colloids. The use of separation media comprising silica nanoparticles is further discussed in U.S. Patent Application Publication No. 2015/0279648A1, as published Oct. 1, 2015, which is entirely incorporated by reference herein for all purposes.

The capillary electrophoresis tube can be formed from, for example, plastic or fused silica. In some embodiments, the diameters of the capillary inlet and the capillary outlet are in a range from about 5 μm to about 500 μm. The diameters of the capillary inlet and outlet can be, for example, in a range between about 5 μm and about 80 μm, between about 10 μm and about 125 μm, between about 15 μm and about 200 μm, between about 20 μm and about 300 μm, or between about 30 μm and about 500 μm. The diameters of the capillary inlet and outlet can be between about 20 μm and about 60 μm, between about 25 μm and about 70 μm, between about 30 μm and about 85 μm, between about 35 μm and about 100 μm, or between about 40 μm and about 125 μm. In some embodiments, the diameters of the capillary inlet and outlet are about 50 μm. In some embodiments, the diameters of the capillary inlet and the capillary outlet are about 1, 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 600, 700, 800, 900, or 1000 μm.

The first and second electrodes can be formed from any conducting or semiconducting material. For example, in some embodiments, one or both or the electrodes comprise a metal. In some embodiments, the metal is gold or platinum. For example, one or both of the electrodes can be platinum or can be platinum-plated. One or both of the electrodes can be substantially cylindrical in shape, as in a wire. One or both of the electrodes can also be substantially flattened in shape so as to increase their surface area. The apparatus can further include other electrodes in addition to the first and second electrodes. The additional electrodes can have compositions or configurations identical to or different from those of the first and second electrodes. In some embodiments, multiple electrodes in electrical connection with the apparatus can be controlled independently, simultaneously, or in different combinations in operating the apparatus.

The voltage at the first electrode can be held at a different voltage than that at the second electrode. The difference in voltages can cause analytes in the capillary electrophoresis tube to separate from one another in a technique known as electrophoresis. Electrophoresis is the induced motion of particles suspended in a fluid by an electric field, or as otherwise known in the art. Electrophoresis of positively charged particles (cations) is often called cataphoresis, while electrophoresis of negatively charged particles (anions) is often called anaphoresis.

Motion of analytes or other material within the capillary electrophoresis tube can occur soleley through electrophoresis. There can also a bulk fluid flow through the capillary electophoresis tube that contributes to the motion of analytes or other material. In some embodiments, the analytes or other materials within the capillary electrophoresis tube move only through the action of bulk fluid flow within the tube.

In certain aspects, the electrophoresis systems and methods of the present invention resolve or separate the analyte as a function of the pI of the analyte. The isoelectric point (pI) is the pH at which a particular molecule carries no net electrical charge. Other suitable techniques for resolution or separation include, but are not limited to, electrophoresis, isoelectric focusing, ion exchange chromatography, cation exchange chromatography, and hydrophobic interaction chromatography. Resolution can also be conducted using affinity chromatography, wherein separation results from interaction of one or more analytes with binding moieties such as antibodies, lectins, and aptamers, in the separation bed.

In some embodiments, one or more analytes are separated within the the capillary tube by isoelectric focusing prior to subsequent movement of the analytes within the tube by a bulk fluid flow. It is to be understood that the separated analyte or material can be a portion of all of the analyte or material within the capillary tube. The capillary electrophoresis tube, optional sieving matrix, and related separation process can function to stratify analytes or material prior to their dispensing. In some embodiments, one or more analytes are moved within the capillary tube by a bulk fluid flow prior to their subsequent separation within the tube by isoelectric focusing. In one provided embodiment of a method, an isoelectric focusing step is used to separate one or more analytes within the tube, a bulk fluid flowing step is used to move the one or more analytes into the dispensing apparatus, and a dispensing step is used to dispense the one or more analytes onto a surface.

At least a portion of the microfluidic pump chamber comprises a deformable surface. The deformable surface can be connected to the impulsive pump element. The deformable surface can be configured to expand, to contract, or both. The movement of the deformable surface alters the volume of the pump internal region. As the volume of the pump internal region decreases, liquid contained within the pump internal region can be dispensed through the nozzle outlet of the microfluidic nozzle.

The impulsive pump element can comprise a piezoelectric material. In some embodiments, the impulsive pump element comprises a piezoelectric crystal. In some embodiments, the impulsive pump element comprises lead zirconate titanate. The impulsive pump element can comprise a thermoresistive material. The impulsive pump element can be electrically connected to an impulsive pump actuator. In some embodiments, the impulsive pump actuator can transmit a signal to the impulsive pump element causing it to expand, contract, or expand and contract. The expansion of the impulsive pump element can deform a portion of the microfluidic pump chamber and can result in the dispensing of liquid through the nozzle outlet of the microfluidic nozzle.

A portion of the capillary electrophoresis tube can be located within the pump inlet. In some embodiments, the capillary electrophoresis tube transits through the microfluidic pump chamber with a portion of the electrophoresis tube extending through the pump inlet of the microfluidic pump chamber to the tapered internal region of the microfluidic nozzle.

The nozzle outlet can have any shape that is capable of allowing the formation of droplets of dispensed fluid. The nozzle outlet can have a circular or ovoid shape. The nozzle outlet can have a triangular, rectangular, or other polygonal shape. The nozzle outlet shape can have two or more axes of symmetry. The diameter or major axis of the nozzle outlet can be larger than, equal to, or smaller than the diameter of the capillary outlet. In some embodiments, the diameter of the nozzle outlet is in the range from about 5 μm to about 200 μm. The diameter of the nozzle outlet can be in the range between about 5 μm and about 500 μm. The diameter of the nozzle outlet can be, for example, in a range between about 5 μm and about 80 μm, between about 10 μm and about 125 μm, between about 15 μm and about 200 μm, between about 20 μm and about 300 μm, or between about 30 μm and about 500 μm. The diameter of the nozzle outlet can be between about 20 μm and about 60 μm, between about 25 μm and about 70 μm, between about 30 μm and about 85 μm, between about 35 μm and about 100 μm, or between about 40 μm and about 125 μm. In some embodiments, the diameter of the nozzle outlet is about 50 μm. In some embodiments, the diameter of the nozzle outlet is about 1, 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 600, 700, 800, 900, or 1000 μm.

At least a portion of the internal region of microfluidic nozzle is tapered such that the cross-sectional area of the nozzle internal region proximate to the nozzle outlet is smaller than the cross-sectional area of the nozzle internal region proximate to the microfluidic pump chamber. In some embodiments, the entire internal region of the microfluidic nozzle is tapered. In some embodiments, only the portion of the nozzle internal region proximate to the nozzle outlet is tapered. The tapering can be such that the cross-sectional area of the nozzle internal region decreases linearly along the longitudinal axis of the nozzle. The tapering can be such that cross-sectional area of the nozzle internal region decreases nonlinearly along the longitudinal axis of the nozzle. The external surface of the microfluidic nozzle can be tapered as well.

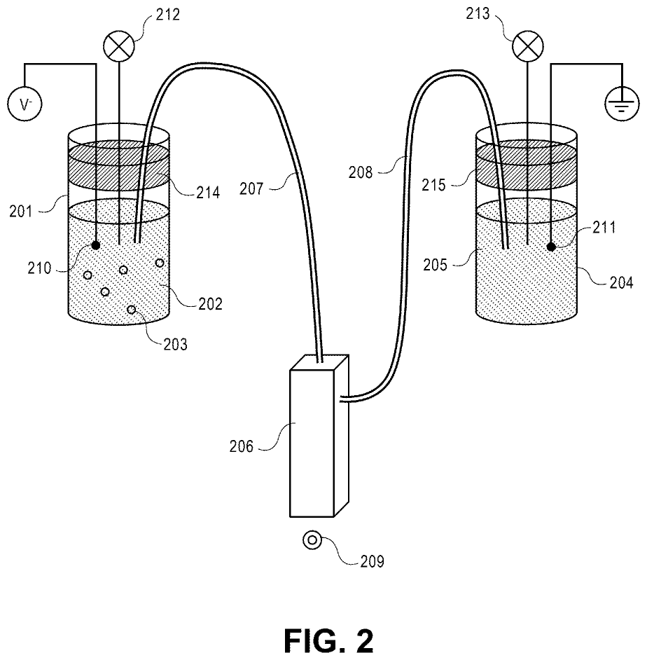

FIG. 2 illustrates one embodiment. Shown is a capillary electrophoresis solution reservoir 201 that holds a capillary electrophoresis solution 202. The capillary electrophoresis solution 202 can comprise one or more dissolved analytes 203. The capillary electrophoresis solution 202 is in fluid connection with a dispensing apparatus 206 via a capillary electrophoresis tube 207.

Also shown is a sheath liquid reservoir 204 that holds a sheath liquid 205. The sheath liquid 205 is in fluid connection with the dispensing apparatus 206 via a sheath flow tube 208.

The dispensing apparatus can be configured as in the device 100 of FIG. 1 to dispense droplets 209 that can comprise a mixture of the capillary electrophoresis solution 202 and the sheath liquid 205. A first electrode 210 is in fluid connection with the capillary electrophoresis solution 202. A second electrode 211 is in fluid connection with the sheath liquid 205. In some embodiments, and as is shown in FIG. 2, the system further comprises a first pressure indicator 212 in fluid connection with the capillary electrophoresis solution 202, and a second pressure indicator 213 in fluid connection with the sheath liquid 205.

One or both of the capillary electrophoresis solution reservoir 201 and/or the sheath liquid reservoir 204 can be configured to maintain their respective interior contents at pressures different from that of the exterior pressure. In this way, a pressure gradient can be maintained for the capillary electrophoresis solution 202 within the capillary electrophoresis tube 207. Similarly, a pressure gradient can be maintained for the sheath liquid 205 within the sheath flow tube 208.

The system can further comprise one or more devices for controlling the pressure of the capillary electrophoresis solution 202 and/or the sheath liquid 205 within their respective reservoirs 201 and 204. In some embodiments, at least a portion of the surfaces of the capillary electrophoresis solution reservoir 201 and/or the sheath liquid reservoir 204 are deformable such that compression or relaxation of the reservoirs increases or decreases the pressures, respectively, of the liquids held within. In some embodiments, the capillary electrophoresis solution 202 and/or the sheath liquid 205 are held within first subchambers of their respective reservoirs 201 and 204. In some embodiments, and as shown in FIG. 2, one or more pistons 214 and 215 exert mechanical pressure on the first subchambers to control the pressures of the liquids held within. In some embodiments, the capillary electrophoresis solution reservoir 201 and/or the sheath liquid reservoir 204 further comprise second subchambers adjacent to the first subchambers. In some embodiments, controlling the volume of a fluid within these second subchambers exerts hydraulic pressure on the first subchambers to control the pressures of the liquids held within.

The control of the pressures of the capillary electrophoresis solution 202 and/or the sheath liquid 205 can further comprise measuring the respective pressures with the pressure indicators capillary electrophoresis solution 202 and/or the sheath liquid 205 within their respective reservoirs 201 and 204 with the pressure indicators 212 and 213.

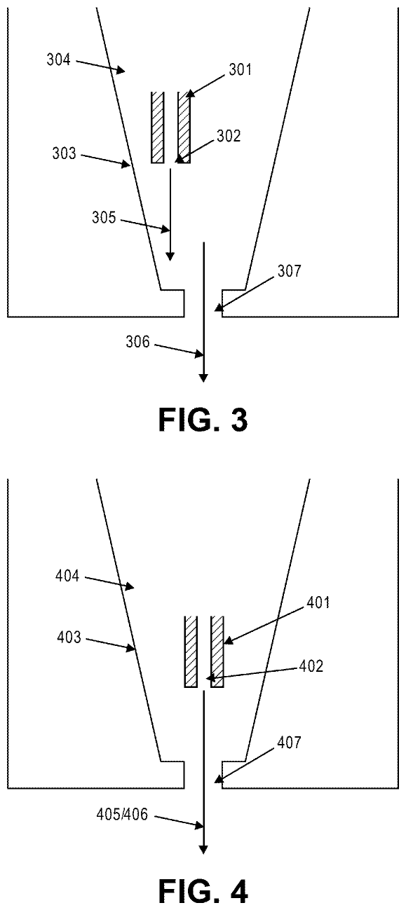

FIG. 3 illustrates an orientation of a portion of a capillary electrophoresis tube 301 with a capillary outlet 302 within a tapered internal region 303 of a microfluidic nozzle 304. A capillary longitudinal axis 305 is the longitudinal axis of the portion of the capillary electrophoresis tube 301 that is proximate to the capillary outlet 302. A nozzle longitudinal axis 306 is the longitudinal axis of the portion of the tapered internal region 303 that is proximate to a nozzle outlet 307. In some embodiments, and as is shown in FIG. 3, the capillary longitudinal axis 305 is parallel to the nozzle longitudinal axis 306.

FIG. 4 illustrates an orientation of a portion of a capillary electrophoresis tube 401 with a capillary outlet 402 within a tapered internal region 403 of a microfluidic nozzle 404. A capillary longitudinal axis 405 is the longitudinal axis of the portion of the capillary electrophoresis tube 401 that is proximate to the capillary outlet 402. A nozzle longitudinal axis 406 is the longitudinal axis of the portion of the tapered internal region 403 that is proximate to a nozzle outlet 407. In some embodiments, and as is shown in FIG. 4, the capillary longitudinal axis 405 is coaxial with the nozzle longitudinal axis 406.

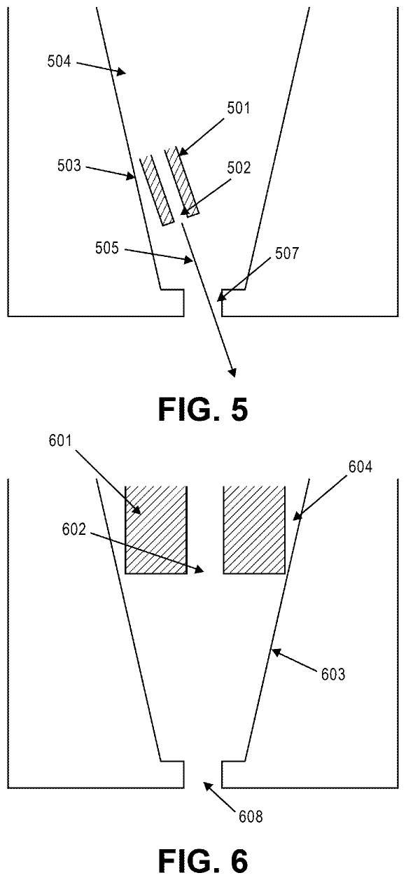

FIG. 5 illustrates an orientation of a portion of a capillary electrophoresis tube 501 with a capillary outlet 502 within a tapered internal region 503 of a microfluidic nozzle 504. A capillary longitudinal axis 505 is the longitudinal axis of the portion of the capillary electrophoresis tube 501 that is proximate to the capillary outlet 502. In some embodiments, and as is shown in FIG. 5, the capillary longitudinal axis 505 extends through a nozzle outlet 507 of the microfluidic nozzle 504.

As separated material exits the capillary electrophoresis tube through the capillary outlet, the material is exposed to the sheath liquid and mixes with it prior to being dispensed through the nozzle outlet in the form of a mixture. The effective volume for this mixing is determined in part by the direction of flow for material exiting the capillary electrophoresis tube. If the capillary outlet were pointed away from or perpendicular to the nozzle outlet, the effective mixing volume would be increased because the eluted material can flow in a direction opposite to that of dispensing. This would dilute the eluted material within the sheath liquid and increase the likelihood that material eluted from the capillary electrophoresis tube at different times can be present in the same mixture dispensed through the nozzle outlet. In either case, the result will be an undesirable decrease in the concentration and/or resolution of dispensed separated material.

A technical advantage of the embodiments illustrated in FIGS. 3, 4, and 5 is that a bulk fluid flow of material exiting the capillary electrophoresis tube will be traveling in a direction substantially towards the nozzle outlet. This has the effect of reducing the effective mixing volume with the sheath liquid and increasing the concentration and/or resolution of dispensed separated material.

The movement of material within the microfluidic nozzle is determined in part by the presence, directions, and magnitudes of sheath liquid flow, bulk fluid flow output from the capillary electrophoresis tube, and an electrical field within the capillary electrophoresis tube and the microfluidic nozzle. In some embodiments, the contribution of bulk fluid flow is greater than that of an electrical field, and accordingly the movement of material within the microfluidic nozzle is in a direction substantially towards the nozzle outlet.

In some embodiments, portions of the capillary electrophoresis tube internal and/or external to the microfluidic pump chamber are coaxial with the portion of the capillary electrophoresis tube proximate to the capillary outlet. In some embodiments, portions of the capillary electrophoresis tube internal and/or external to the microfluidic pump chamber are not coaxial with the portion of the capillary electrophoresis tube proximate to the capillary outlet.

In some embodiments, the capillary outlet terminates in a range between about 5 μm and about 500 μm from the nozzle outlet. The capillary outlet can terminate, for example, in a range between about 5 μm and about 80 μm, between about 10 μm and about 125 μm, between about 15 μm and about 200 μm, between about 20 μm and about 300 μm, or between about 30 μm and about 500 μm from the nozzle outlet. The capillary outlet can terminate in a range between about 20 μm and about 60 μm, between about 25 μm and about 70 μm, between about 30 μm and about 85 μm, between about 35 μm and about 100 μm, or between about 40 μm and about 125 μm from the nozzle outlet. In some embodiments, the capillary outlet terminates about 50 μm from the nozzle outlet.

The portion of the capillary electrophoresis tube proximate to the capillary outlet can be tapered such that the cross-sectional area of the capillary electrophoresis tube proximate to the capillary outlet is smaller than the cross-sectional area of the capillary electrophoresis tube proximate to the microfluidic pump chamber. The tapering can be such that the cross-sectional area of the capillary electrophoresis tube decreases linearly along the capillary longitudinal axis. The tapering can be such that cross-sectional area of the capillary electrophoresis tube decreases nonlinearly along the capillary longitudinal axis.

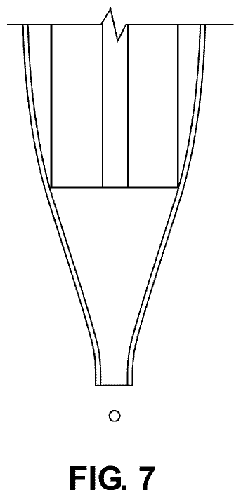

FIG. 6 illustrates a configuration of a capillary electrophoresis tube outlet region. A portion of a capillary electrophoresis tube 601 with a capillary outlet 602 terminates within a tapered internal region 603 of a microfluidic nozzle 604.

FIG. 7 is a stroboscopic image showing successful droplet dispensing with a capillary located concentrically within a piezoelectric inkjet dispenser as illustrated in FIG. 6.

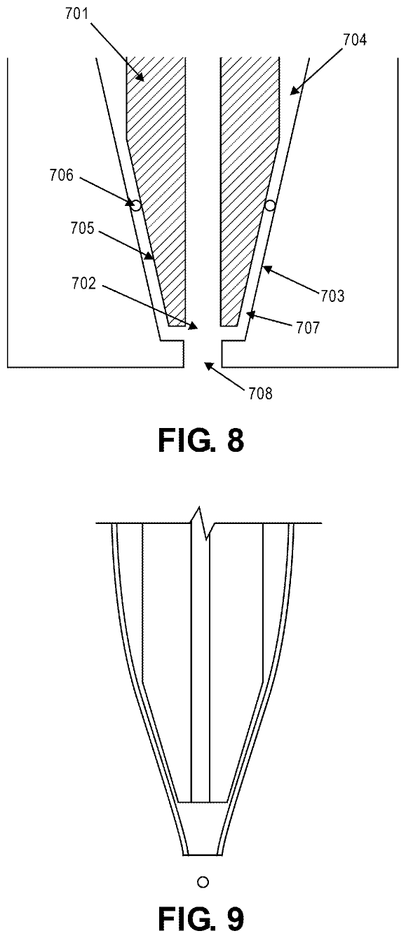

FIG. 8 illustrates a configuration of a capillary electrophoresis tube outlet region. A portion of a capillary electrophoresis tube 701 with a capillary outlet 702 terminates within a tapered internal region 703 of a microfluidic nozzle 704. The capillary electrophoresis tube 701 comprises a capillary electrophoresis tube tapered region 705 and a spacer 706 configured to create a void space 707 between the capillary electrophoresis tube tapered region 705 and the tapered internal region 703 of the microfluidic nozzle 704. As is shown in FIGS. 6 and 8, the use of a capillary electrophoresis tube tapered region allows the capillary outlet 602/702 to be positioned closer to the nozzle outlet 608/708.

FIG. 9 is a stroboscopic image showing successful droplet dispensing with a tapered capillary located concentrically within a piezoelectric inkjet dispenser as illustrated in FIG. 8. The tapered capillary shown in FIGS. 8 and 9 can be located significantly closer to the outlet of the dispenser than the blunt-end standard capillary of FIGS. 6 and 7, which can enable better separation resolution. This improved resolution retention can be due to a significant reduction in mixing volume analytes are exposed to between the separation column and the jetting orifice.

As separated material exits the capillary electrophorese tube through the capillary outlet, the material is exposed to the sheath liquid and mixes with it prior to being dispensed through the nozzle outlet in the form of a mixture. The effective volume for this mixing is determined in part by the distance between the capillary outlet and the nozzle outlet. If the capillary outlet were located at a greater distance from the nozzle outlet, the effective mixing volume would be increased. This would dilute the eluted material within the sheath liquid, and increase the likelihood that material eluted from the capillary electrophoresis tube at different times can be present in the same mixture dispensed through the nozzle outlet. In either case, the result will be an undesirable decrease in the concentration and/or resolution of dispensed separated material.

A technical advantage of the embodiment illustrated in FIGS. 8 and 9 is that material exiting the capillary electrophoresis tube will travel along a shorter path from the capillary outlet to the nozzle outlet. This has the effect of reducing the effective mixing volume with the sheath liquid and increasing the concentration and/or resolution of dispensed separated material.

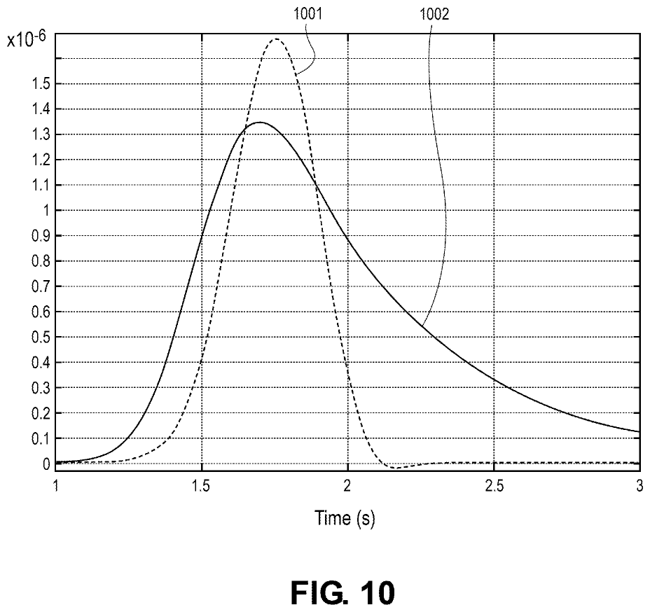

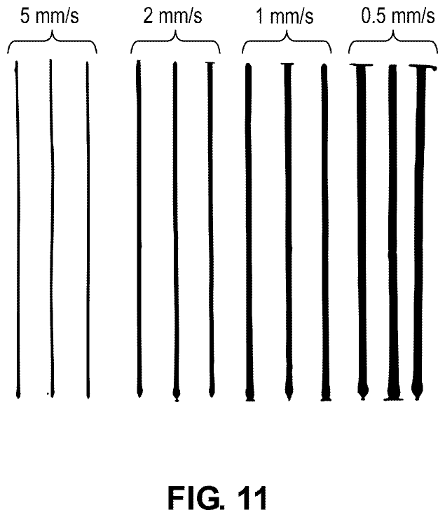

FIG. 10 is a graph of predicted output signals for capillary inkjet dispensers using tapered and standard capillaries. The data trends in the graph were generated from finite element analyses using software from COMSOL (Burlington, MA). The simulations of these analyses were carried out using geometry as shown in FIGS. 6-9, and an analyte input with a Gaussian distribution having a standard deviation of 0.1 seconds. The trends of the graph show the sharper resolution associated with dispensing using a tapered capillary 1001 versus a standard capillary 1002.

A spacer can be used to locate the capillary electrophoresis tube within the microfluidic nozzle. The spacer can create a void space between the capillary electrophoresis tube tapered region and the internal tapered region of the microfluidic nozzle. The void space created can allow the sheath liquid to flow from the microfluidic pump chamber to the region of the microfluidic nozzle proximate to the capillary outlet and the nozzle outlet. In some embodiments, the spacer is an element of the capillary electrophoresis tube, that is, integrally formed with the capillary electrophoresis tube. In some embodiments, the spacer is an element of the microfluidic nozzle, that is, integrally formed with the microfluidic nozzle. “Integrally formed” refers to two or more parts or elements that are formed or manufactured together as a single piece rather than being formed separately and then subsequently joined or assembled. In some embodiments, the spacer is a washer. In some embodiments, the spacer is a conical washer, a curved disc spring washer, or a split washer.

The capillary electrophoresis tube can be used to separate one or more analytes moving within the tube. An “analyte” includes a substance of interest such as a biomolecule. Biomolecules are molecules of a type typically found in a biological system, whether such molecule is naturally occurring or the result of some external disturbance of the system (e.g., a disease, poisoning, genetic manipulation, etc.), as well as synthetic analogs and derivatives thereof. Non-limiting examples of biomolecules include amino acids (naturally occurring or synthetic), peptides, polypeptides, glycosylated and unglycosylated proteins (e.g., polyclonal and monoclonal antibodies, receptors, interferons, enzymes, etc.), nucleosides, nucleotides, oligonucleotides (e.g., DNA, RNA, PNA oligos), polynucleotides (e.g., DNA, cDNA, RNA, etc.), carbohydrates, hormones, haptens, steroids, toxins, etc. Biomolecules can be isolated from natural sources, or they can be synthetic. The analyte can be, for example, an enzyme or other protein. The analyte can be a peptide or a polypeptide. The analyte can be an antibody or a fragment of an antibody. The analyte can be a nucleic acid molecule. The analyte can include deoxyribonucleic acids (DNA) or ribonucleic acids (RNA). The analyte can be a polynucleotide or other polymer.

The analytes can thus be, for example, proteins, nucleic acids, carbohydrates, lipids, or any other type of molecule. In some embodiments, the analytes are proteins that are present in the capillary electrophoresis tube in their native state. In some embodiments, the analytes are proteins that have been mixed with sodium dodecyl sulfate, sodium deoxycholate, nonyl phenoxypolyethoxylethanol, TRITON X-100™, or other ionic detergents or lysis buffers to cause their partial or complete denaturation.

A voltage potential can be applied through the capillary electrophoresis tube between the first and second electrodes. The power for applying a voltage can supply an electric field having voltages of about 1 V/cm to 2000 V/cm. In some embodiments, the voltage is about 1, 10, 20, 30, 40 , 50, 60, 70, 80, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000 V/cm. Higher voltages can also be used, depending on the particular separation method.

The dispensing can generate the formation of a continuous, semi-continuous, or discontinuous stream exiting the nozzle outlet. The dispensing can generate the formation of droplets exiting the nozzle outlet. The droplets can have volumes in the range from about 10 picoliter to about 10 nanoliter. The frequency of the droplets can be in a range from 0 to about 10,000 Hz.

The term “droplet” refers to a small volume of liquid, typically with a spherical shape, encapsulated by an immiscible fluid, such as a continuous phase or carrier liquid of an emulsion. In some embodiments, the volume of a droplet and/or the average volume of droplets is, for example, less than about one microliter (or between about one microliter and one nanoliter or between about one microliter and one picoliter), less than about one nanoliter (or between about one nanoliter and one picoliter), or less than about one picoliter (or between about one picoliter and one femtoliter), among others. In some embodiments, a droplet has a diameter (or an average diameter) of less than about 1000, 100, or 10 μm, or of about 1000 to 10 μm, among others. A droplet can be spherical or nonspherical. A droplet can be a simple droplet or a compound droplet, that is, a droplet in which at least one droplet encapsulates at least one other droplet.

The droplets can be monodisperse, that is, of at least generally uniform size, or can be polydisperse, that is, of various sizes. If monodisperse, the droplets can, for example, vary in volume by a standard deviation that is less than about plus or minus 100%, 50%, 20%, 10%, 5%, 2%, or 1% of the average droplet volume.

The droplets or stream once dispensed can be contacted with a surface. In some embodiments, the surface comprises an electrically insulating material. In some embodiments, the surface comprises an electrically conductive material. In some embodiments, the nozzle outlet contacts the surface. In some embodiments, the nozzle outlet does not contact the surface. In some embodiments, the surface is located about 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, or 100 mm from the nozzle outlet. The surface can be positioned perpendicular to the nozzle longitudinal axis. The surface can be positioned at an acute angle to the nozzle longitudinal axis.

FIG. 11 is an image of triplicate traces created by dispensing 100 drops/second onto a nitrocellulose membrane moving at 5, 2, 1, and 0.5 mm/second. The dispensed droplets include SAv-800CW dye that can be readily visualized. Each set of triplicate traces shown demonstrates the uniformity and consistency of dispensing that can be achieved with the provided devices and methods. Also, the differences in line thicknesses and dye intensities between the four different triplicate sets show the ability to control dispensing amounts.

In some embodiments, the surface comprises a hydrophilic material. In some embodiments, the surface comprises a hydrophobic material. In some embodiments, the degree of hydrophobicity of the surface affects the surface area of droplets once contacted with the surface. In general, for aqueous droplets, as the hydrophobicity of the surface increases, the contact angle of the droplets with the surface will decrease. This decreased contact angle can allow the distances between adjacent droplets on the surface to be reduced while still preventing droplets from coalescing or otherwise combining with one another. In this way, the use of a hydrophobic surface material can enable a greater concentration of distinct droplets to be dispensed onto the surface. Also, for each individual droplet, the concentration of dispensed material per unit of area of the contacted surface material will increase. In some embodiments, this increased concentration can lead to greater signal intensities for applications such as Western blotting.

In some embodiments, the surface material is selected such that adjacent droplets dispensed onto the surface remain distinct. These embodiments can generate dispensed patterns that maintain the resolution of the separation of material within the capillary electrophoresis tube and the dispensing apparatus. In some embodiments, the surface material is selected such that adjacent droplets dispensed onto the surface coalesce. Through movement of one or both of the surface and/or the dispensing apparatus during dispensing, these embodiments can generate dispensed patterns that are continuous or semi-continuous linear, curved, or semi-curved representations of the separation of material within the capillary electrophoresis tube.

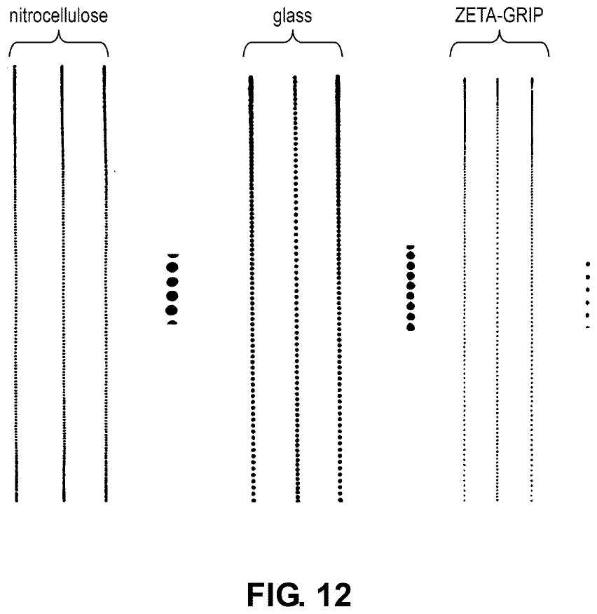

FIG. 12 is an image of triplicate traces created by dispensing drops onto three different surface materials. The left three traces show drops after dispensing onto a nitrocellulose membrane, the middle traces show drops after dispensing onto a nitrocellulose on glass membrane, and the right traces show drops after dispensing onto a ZETA-GRIP™ hydrophobic membrane. Within each set, the consistency among the triplicate repeats again demonstrates to reproducibility of the provided devices and methods. In comparing results from dispensing onto the three different materials, it can be seen that the hydrophobic membrane provides the smallest dispensed drop diameters, and as a result, the highest signal intensity relative to background.

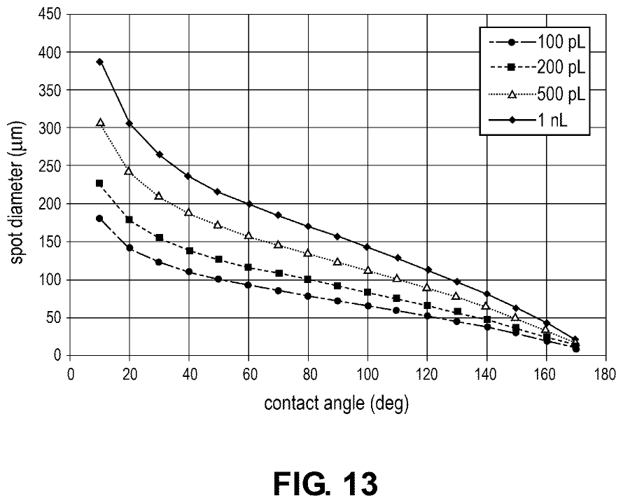

FIG. 13 a graph of calculated spot diameters versus substrate contact angles for dispensed drops of various volumes. “Contact angle” refers to an angle formed between a horizontal solid surface and the liquid surface of a droplet maintaining a lens shape when placed on the solid surface. The lens shape and contact angle are characteristic of the liquid and solid surface properties. As the hydrophobicity of a solid surface increases, its water contact angle will also increase. The trends in the graph demonstrate that for these increasing water contact angles, the average diameters of dispensed drops will decrease. Additionally, for a surface with a given hydrophobicity and contact angle, the spot diameter can also be controlled by varying the volumes of the dispensed drops, with smaller droplet volumes resulting in smaller spot diameters.

In some embodiments, the surface is a component of a fraction collection device. In some embodiments, the surface is located within a well of a microwell plate. The microwell plate can comprise an array of a plurality of wells. The number of wells arrayed on the microwell plate can be, for example, 6, 24, 96, 384, 1536, 3456, or 9600, or more.

In some embodiments, the surface is a blotting membrane that can be useful for performing a Western immunoassay or other membrane analysis methods such as Northern blotting and Southern blotting. The method can further comprise applying a detection reagent to such a blotting membrane. The detection reagent can be an antibody such as a primary or secondary antibody.

The term “antibody” includes a polypeptide encoded by an immunoglobulin gene or functional fragments thereof that specifically binds and recognizes an antigen. Immunoglobulin genes include the kappa, lambda, alpha, gamma, delta, epsilon, and mu constant region genes, as well as the myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively. The term antibody activity, or antibody function, refers to specific binding of the antibody to the antibody target.

A primary antibody will be understood by one of skill to refer to an antibody or fragment thereof that specifically binds to an analyte (e.g., substance, antigen, component) of interest. The primary antibody can further comprise a tag, e.g., for recognition by a secondary antibody or associated binding protein (e.g., green fluorescent protein (GFP), biotin, or strepavidin).

A secondary antibody refers to an antibody that specifically binds to a primary antibody. A secondary antibody can be specific for the primary antibody (e.g., specific for primary antibodies derived from a particular species) or a tag on the primary antibody (e.g., GFP, biotin, or strepavidin). A secondary antibody can be bispecific, e.g., with one variable region specific for a primary antibody, and a second variable region specific for a bridge antigen.

Blotting membranes can comprise, for example, nitrocellulose, nylon, polyvinylidene difluoride, or combinations of one or more of these materials. The blotting membrane can further comprise a support material. The support material can be, for example, glass, plastic, metal, ceramic or other inert surface.

The provided method can further comprise moving the position of the surface relative to that of the dispensing device. The moving can comprise changing the location of the surface as the dispensing device is stationary. The moving can comprise changing the location of the dispensing device and the surface is stationary. The moving can comprise changing the locations of both the surface and the dispensing device. The moving can comprise changing the location of the surface in one direction and changing the location of the dispensing device in an orthogonal direction.

The moving of the surface relative to the dispensing device can comprise the use of motors. The dispensing device can also or alternatively be moved relative to the surface. This movement of the dispensing device can also include the use of motors. The motors can be, for example, stepper motors, small brushed direct current (DC) motors, or brushless DC motors. The motors can be elements of a robotic apparatus that is programmed or otherwise configured to automate and/or regulate the operation of the motors.

The method can utilize a computing apparatus that is programmed or otherwise configured to automate and/or regulate one or more steps of the method provided herein. Some embodiments provide machine executable code in a non-transitory storage medium that, when executed by a computing apparatus, implements any of the methods described herein. In some embodiments, the computing apparatus operates one or more of the pressure of the capillary electrophoresis solution reservoir, the pressure of the sheath liquid reservoir, the flow of liquid through the capillary electrophoresis tube, the flow of liquid through the sheath flow tube, the activity of the impulsive pump actuator, the moving of the surface, or the moving of the dispensing apparatus.

The term “automated” refers to a device, action, or method carried out by a machine or computer without direct human control. In some embodiments, the device and method described herein is operated in an automated fashion. In some embodiments, the automated method has subjective start and end points, thus the term does not imply that all steps of the operation are carried out automatically.

Also provided are devices that comprise a plurality of dispensing units. The dispensing units can be configured in a linear array. The dispensing units can be configured in a 2-dimensional array. In some embodiments, the device comprises 1, 2, 4, 8, 12, or more dispensing units. Some or all of the dispensing units can each be connected to the same supply of sheath liquid. Some or all of the dispensing units can each be connected to different supplies of sheath liquid. Each of the different sheath liquid supplies can include the same or different sheath liquid compositions. Some or all of the dispensing units can each be connected to the same capillary electrophoresis solution reservoir. Some or all of the dispensing units can each be connected to different capillary electrophoresis solution reservoirs. Each of the different capillary electrophoresis solution reservoirs can include the same or different capillary electrophoresis solution compositions.

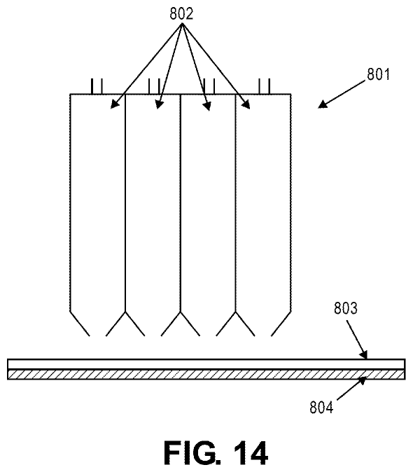

FIG. 14 illustrates a system with an array 801 of four dispensing units 802 positioned above a dispensed mixture receiving surface 803 that is connected to a support surface 804.

The devices and methods provided herein can be used for dispensing separated material at high-resolution. The devices and methods can also be used to dispense material at high concentrations and/or low volumes. In some embodiments, the dispensed material is not separated by a capillary electrophoresis column but is instead output into the sheath liquid proximate to the nozzle outlet for subsequent dispensing. In this way, the devices and methods can be used to deliver discrete aliquots of materials at high concentration and/or low volume. The aliquots can be of a uniform material or of a mixture of materials that are at least partially combined within the provided dispensing device. The dispensed material can include, for example, antibodies, blocking reagents, or other components of chemical or biological processes. The devices and methods can be used to deliver material to downstream process such as a separation process, a non-separation process such as mass spectrometry, or a microfluidic droplet chemistry process.

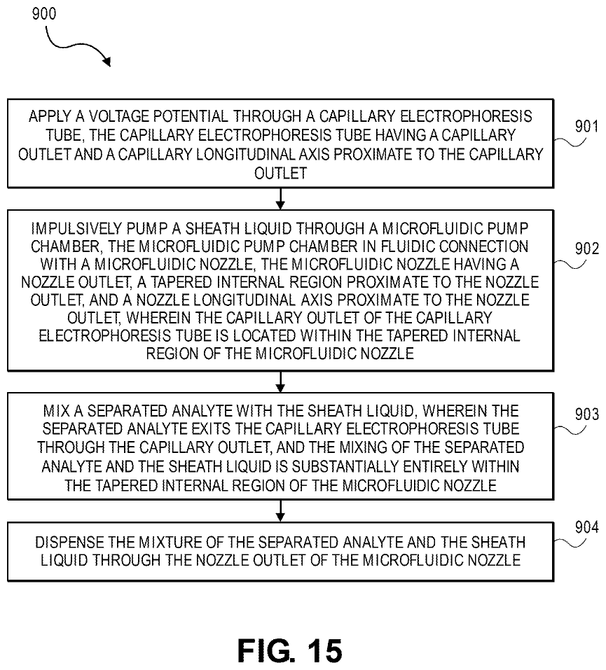

FIG. 15 is a flowchart of a process 900 in accordance with an embodiment. In operation 901, a voltage potential is applied through a capillary electrophoresis tube, the capillary electrophoresis tube having a capillary outlet, and a capillary longitudinal axis proximate to the capillary outlet. In operation 902, a sheath liquid is impulsively pumped through a microfluidic pump chamber, the microfluidic pump chamber in fluidic connection with a microfluidic nozzle, the microfluidic nozzle having a nozzle outlet, a tapered internal region proximate to the nozzle outlet, and a nozzle longitudinal axis proximate to the nozzle outlet, wherein the capillary outlet of the capillary electrophoresis tube is located within the tapered internal region of the microfluidic nozzle. In operation 903, a separated analyte is mixed with the sheath liquid, wherein the separated analyte exits the capillary electrophoresis tube through the capillary outlet, and the mixing of the separated analyte and the sheath liquid is substantially entirely within the tapered internal region of the microfluidic nozzle. In operation 904, the mixture of the separated analyte and the sheath liquid is dispensed through the nozzle outlet of the microfluidic nozzle.

Systems that incorporate the apparatus are also provided. Systems can include, for example, a power supply and power regulator to control the current and/or voltage to the first and second electrodes and the impulsive pump actuator. Additionally, pressure sources for regulating the flow of liquids, mechanisms for stirring or mixing liquids, and heating or cooling units can be included.

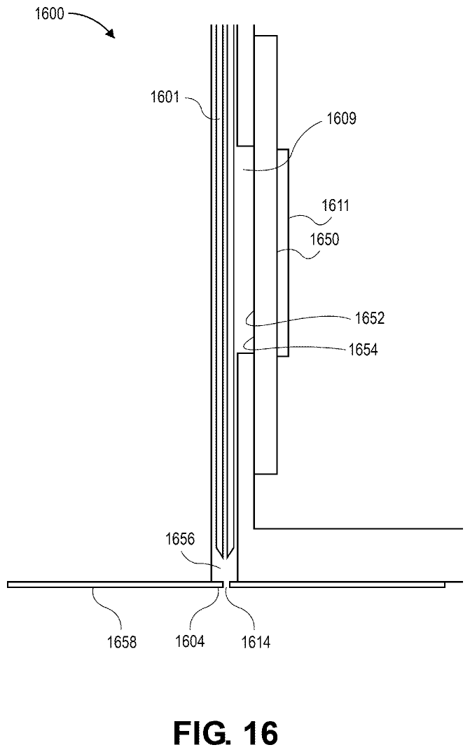

FIG. 16 illustrates a cross-section of a flat piezoelectric actuator working with a single capillary in accordance with an embodiment. In device 1600, separation column 1601 is aligned in the direction of nozzle outlet orifice 1614 and droplet trajectory. That is, the longitudinal axis of the separation column's exit is parallel with and coaxial to the axis of the nozzle orifice.

Capillary electrophoresis tube separation column 1601 exits into nozzle volume 1656, which is adjacent and proximate nozzle outlet 1614 of nozzle 1604. Nozzle outlet is a precision machined hole in orifice plate 1658. Nozzle volume 1656 is fluidically connected with pump chamber 1609 above.

Flat piezoelectric actuator 1611 is intimately affixed to flat wall 1650 on the right side of pump chamber 1609 in the figure. When actuator 1611 expands or contracts, it moves wall 1650 along with it. Internal surface 1652 of wall 1650 forms deformation surface 1654 that is in contact with sheath fluid within pump chamber 1609. Deformation surface 1654, which is the surface that moves when actuator 1611 actuates, is largely commensurate with internal surface 1652. When deformed by actuator 1611, deformation surface 1654 forms pressure waves through the sheath liquid within pump chamber 1609. The pressure waves travel everywhere through pump chamber 1609, including downward past the tip of the outlet of separation column 1601. The pressure waves draw a nano- or pico-liter sized volume of separated analyte eluted from separation column 1601 with the sheath fluid toward the orifice 1614. The analyte and sheath fluid eject from the nozzle outlet orifice 1614 as a tiny drop. Repeated pressure waves create a bulk flow when the fluid must replenish the volume lost with each droplet. The pressure waves indirectly move the analyte toward the outlet.

In the figure, nozzle 1604 is not tapered; however, a tapered tip is possible, which may improve mixing or focus the power transfer efficiency of the pressure wave of sheath fluid to form a droplet.

For electrophoresis, a voltage is supplied between an electrode in the inlet of the capillary tube and a ground in the sheath fluid. The ground electrode can be near the exit of the capillary tube or anywhere in the sheath fluid, such as in the pump chamber, nozzle volume, reservoir, inputs or outputs, or connecting regions. This is because the sheath fluid is in fluidic contact with the liquid in the capillary tube. The ground electrode can be shared among multiple capillary separate tubes.

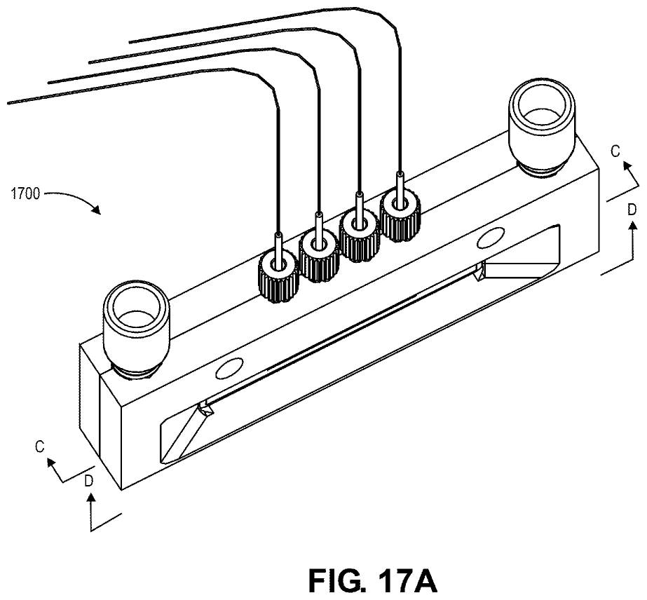

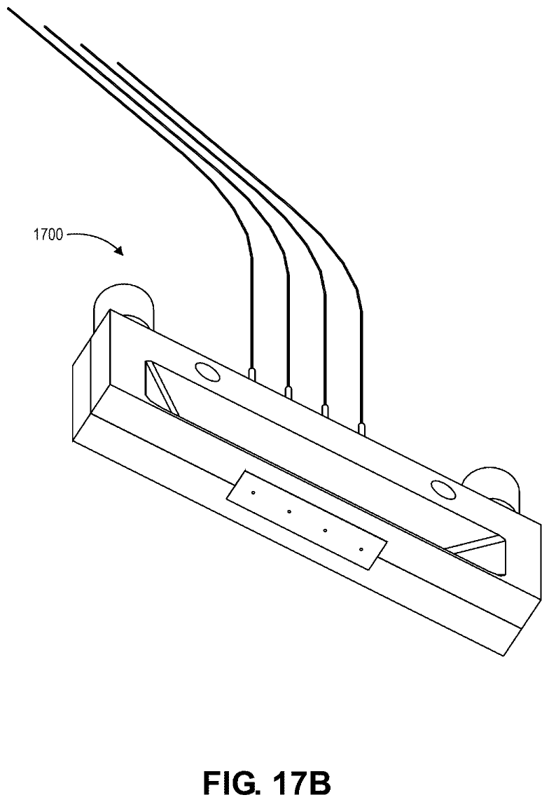

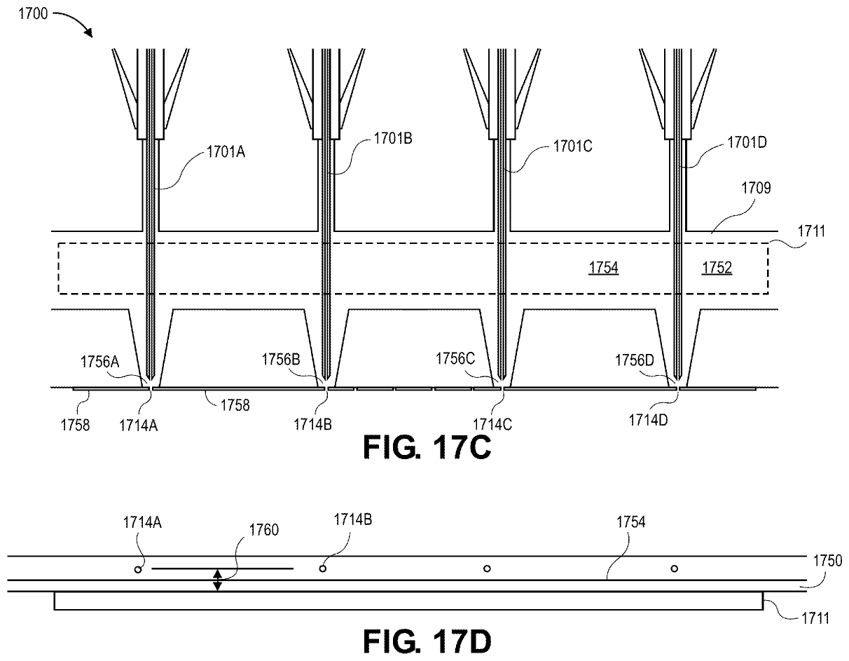

FIGS. 17A-17D illustrate a flat actuator spanning between multiple capillaries in accordance with an embodiment. As in the previous figures, each capillary separation column 1701A, 1701B, 1701C, and 1701D is aligned in the direction of its respective outlet orifice 1714A, 1714B, 1714C, and 1714D and droplet trajectory. In this embodiment, four capillaries and four orifices are shown.

The nozzles have individual tapered regions near the ends of the separations columns and orifices forming nozzle volumes 1756A, 1756B, 1756C, and 1756D. In some embodiments they can share a single, common tapered nozzle volume. In other embodiments, they can share nozzle volumes in subsets with one another, for example with two or more capillaries sharing one nozzle volume and two or more other capillaries sharing another nozzle volume.

This multiple capillary configuration uses single, flat actuator 1711 on one side of common pump chamber 1709. Flat actuator 1711 is underneath the capillaries and pressure chamber in the figure. Flat bar actuator 1711 spans across pump chamber 1709 in which multiple separation columns 1701A-1701D are aligned in the direction of multiple orifices 1714A-1714D (one for each column). As in the previous embodiment, immediately across flat wall 1750 from actuator 1711 is inside portion 1752 of the wall. This inside portion of the wall deforms the greatest amount and commensurate with deformation surface 1754. As can be seen from FIG. 17D, which shows distance 1760 between nozzle outlets 1714A and 1714B and actuator 1711, the closest portion of actuator 1711 or deformation wall 1754 to each capillary exit is the same. No portion is closer. Thus, a planar pressure wave traveling directly from the deformation wall to the orifices applies an equally intense pressure transient to each of the orifices.

A technical advantage of this configuration is that the equal sized pressure waves will cause equal sized drops to eject from the orifices, given that other things, like the orifice sizes, are the same. Equal size drops may be important for defining distinct spots on a common blotting membrane.

Another technical advantage of the configuration is that throughput is improved via parallelization. With N separation capillaries, a total of N separations occur within the same timeframe as a single separation in a single-capillary device. They can all be deposited and affixed onto a storable membrane for later analysis and comparison. Further, the cost of the device can be lowered by using a single actuator instead of multiple actuators and thus provide a single drive circuit for N capillaries, as opposed to N actuators with N drive circuits.

Analytes may be separated in capillaries using electrophoresis or other techniques such as liquid chromatography. The separated analytes elute from the capillary end near an orifice of the device, and the piezoelectric actuator deforms a diaphragm (wall) to generate acoustic waves which enable drops to emit from the orifice(s). When the capillary end is close enough to the orifice and drops are dispensed at a high enough rate, the analytes are quickly dispensed onto some adjacent surface.

A technical advantage over concentric actuator-around-capillary approaches is that concentric actuators requires individual actuators for each capillary, almost by definition. It also may be less expensive because flat actuators can be cut from large sheets of piezoelectric medium while concentric actuators typically have to be extruded in a tube shape. In regard to the capillary being positioned perpendicularly to the orifice compared to parallel placement, it may be beneficial as it is likely to have less dependence on positioning the capillary (e.g., distance from capillary tip to orifice).

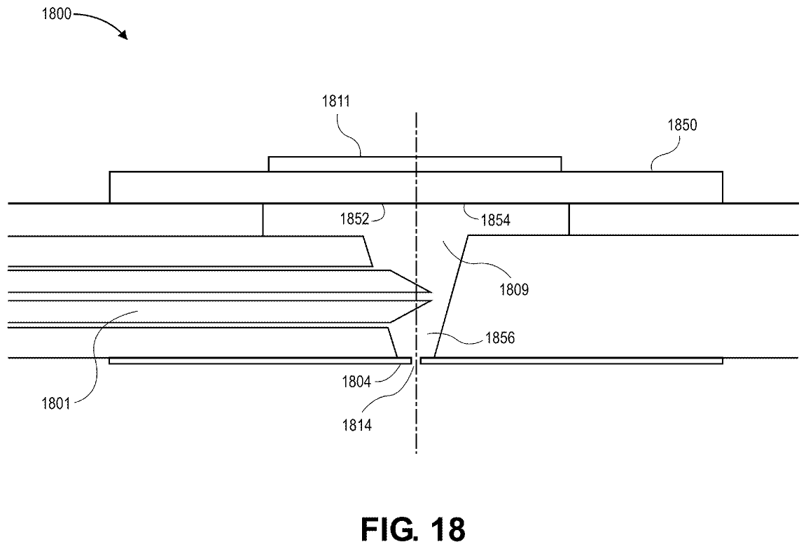

FIG. 18 illustrates a cross-section of system 1800 in which flat actuator 1811 against back wall 1850 of pump chamber 1809 through which separation capillary 1801 exits perpendicularly to nozzle 1804 with nozzle outlet 1814. Within nozzle volume 1856, analyte eluting from separation capillary 1801 is forced downward by bulk flow due to repeated pressure waves of sheath fluid, effectively turning it downward to get ejected through nozzle outlet orifice 1814.

This single capillary configuration uses flat piezoelectric actuator 1811 on one side of pump chamber 1809 that is perpendicular to an axis of orifice 1814. That is, the exit axis of the capillary electrophoresis tube is perpendicular to the orifice and droplet trajectory.

Piezoelectric actuator 1811 expands and/or contracts against back wall 1850, forcing inside 1852 of wall to move slightly. Inside of wall 1852 forms deformation surface 1854. The moving wall causes a pressure wave to pass through the sheath liquid, across the face of the electrophoresis tube exit, and into tapered nozzle volume 1856. At the end of the nozzle is orifice 1814 through which a tiny droplet of analyte from the separation tube and sheath liquid eject.

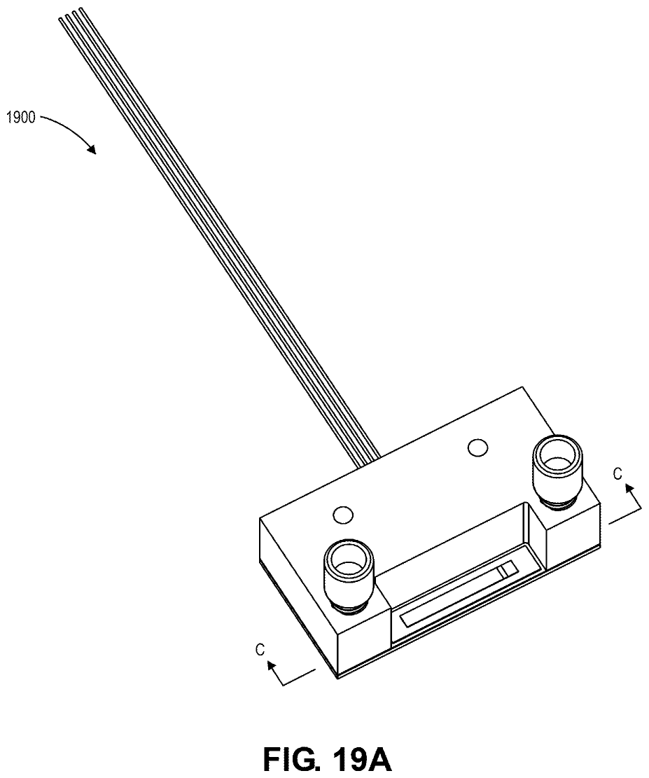

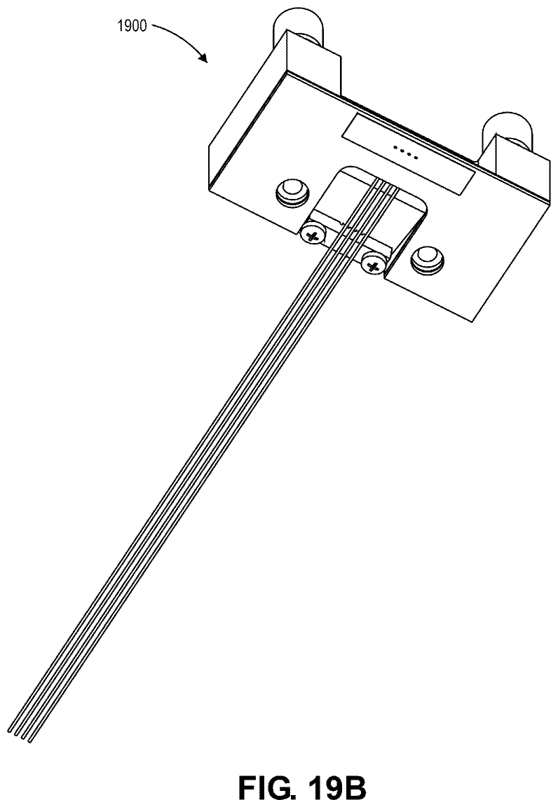

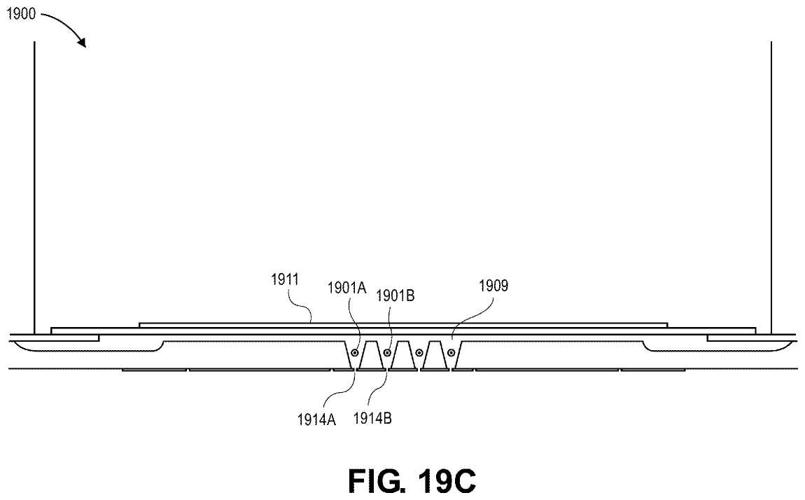

FIGS. 19A-19C illustrate an embodiment with multiple capillaries that exit perpendicularly to their respective nozzles. Out of device 1900, the nozzles are aligned in a line with one another, pointing toward a common target plane below.

Adjacent chamber volumes contain the separation columns that are aligned perpendicular to the orifices and droplet trajectories. Each separation column, such as separation columns 1901A and 1901B, has its own adjacent nozzle volume and nozzle exit 1914A and 1914B, respectively. In the figure, the separation columns are oriented as coming out behind the page. Each separation column may have its own voltage connection (not shown in the figure). A common ground (not shown in the figure) is provided in the pump chamber.

The piezoelectric actuation wall, which is the internal portion of the flat wall that is immediately opposite piezoelectric actuator 1911, moves inward or outward as a plane, causing a relatively planar wavefront pressure wave to move from the wall, through pump chamber 1909, toward the nozzles. Because the wavefront is planar and the capillary and nozzle configurations are the same, the wavefront passes the end of each of the capillaries at the same time and with the same pressure transient. The wavefront continues past the capillary ends to send analyte and sheath liquid fluid out of each orifice in a controlled fashion.

A technical advantage of the long, flat piezoelectric actuator that it is equally distant to each of the nozzles, similar to that in FIG. 17D. Accordingly, the pressure wavefront that passes by each nozzle is equal. The equal pressures cause an equal amount of fluid to eject from each nozzle.

The term “substantially” is used herein to modify a value, property, or degree and indicate a range that is within 70% of the absolute value, property, or degree. For example, an operation that occurs substantially entirely within a region can occur more than 70%, more than 75%, more than 80%, more than 85%, more than 90%, more than 95%, more than 96%, more than 97%, more than 98%, or more than 99% within the region. Similarly, two directions that are substantially identical can be more than 70%, more than 75%, more than 80%, more than 85%, more than 90%, more than 95%, more than 96%, more than 97%, more than 98%, or more than 99% identical.

The terms “about” and “approximately equal” are used herein to modify a numerical value and indicate a defined range around that value. If “X” is the value, “about X” or “approximately equal to X” generally indicates a value from 0.90X to 1.10X. Any reference to “about X” indicates at least the values X, 0.90X, 0.91X, 0.92X, 0.93X, 0.94X, 0.95X, 0.96X, 0.97X, 0.98X, 0.99X, 1.01X, 1.02X, 1.03X, 1.04X, 1.05X, 1.06X, 1.07X, 1.08X, 1.09X, and 1.10X. Thus, “about X” is intended to disclose, e.g., “0.98X.” When “about” is applied to the beginning of a numerical range, it applies to both ends of the range. Thus, “from about 6 to 8.5” is equivalent to “from about 6 to about 8.5.” When “about” is applied to the first value of a set of values, it applies to all values in that set. Thus, “about 7, 9, or 11%” is equivalent to “about 7%, about 9%, or about 11%.”

The terms “first” and “second” when used herein with reference to elements or properties are simply to more clearly distinguish the two elements or properties and unless stated otherwise are not intended to indicate order.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A separation capillary dispensing apparatus, comprising:
a separation capillary tube;
a pump chamber having a flat wall parallel to the separation capillary tube;
a piezoelectric actuator bar intimately affixed to the flat wall of the pump chamber, an internal surface of the flat wall immediately opposite the intimately affixed piezoelectric actuator bar forming a deformation surface; and
a nozzle volume connected with the pump chamber, the separation capillary tube exiting into the nozzle volume proximate to a nozzle outlet.

2. The apparatus of claim 1, wherein the separation capillary tube is a first separation capillary tube, the nozzle volume is a first nozzle volume, and the nozzle outlet is a first nozzle outlet, the apparatus further comprising:
a second separation capillary tube; and
a second nozzle volume connected with the pump chamber, the second separation capillary tube exiting into the second nozzle volume proximate to a second nozzle outlet,
wherein the piezoelectric actuator spans across the pump chamber wall such that the deformation surface is no closer to the second nozzle outlet than the first nozzle outlet.

3. The apparatus of claim 2, wherein the piezoelectric actuator spans across the pump chamber wall such that the deformation surface is no closer to an exit of the second capillary tube than an exit of the first capillary tube.

4. The apparatus of claim 2, wherein the first and second separation capillary tubes are parallel to each other.

5. The apparatus of claim 4, further comprising:
additional separation capillary tubes parallel with the first and second separation capillary tubes; and
additional nozzle volumes connected with the pump chamber, the additional separation capillary tubes exiting into the additional nozzle volumes proximate to respective nozzle outlets,
wherein the piezoelectric actuator has a longitudinal axis that spans across the pump chamber wall perpendicular to the first, second, and additional capillary separation tubes.

6. The apparatus of claim 2, wherein the deformation surface is opposite the first and second nozzle outlets such that longitudinal axes of the first and second nozzles intersect the deformation surface.

7. The apparatus of claim 2, wherein fluid capacities of each of the first and second nozzle volumes are less than 25% of a fluid capacity of the pump chamber.

8. The apparatus of claim 7, wherein fluid capacities of each of the first and second nozzle volumes are less than 10% of a fluid capacity of the pump chamber.

9. The apparatus of claim 1, wherein the separation capillary tube exits into the nozzle volume perpendicularly to the nozzle outlet.

10. The apparatus of claim 1 wherein an exit of the separation capillary tube terminates between about 5 μm and about 500 μm from the nozzle outlet.

11. The apparatus of claim 1 wherein a diameter or a major axis of the nozzle outlet is between about 5 μm and about 200 μm.

12. The apparatus of claim 1 wherein a longitudinal axis of the separation capillary tube is parallel to a longitudinal axis of the nozzle outlet.

13. The apparatus of claim 1 wherein a longitudinal axis of the separation capillary tube extends through the nozzle outlet of the nozzle outlet.

14. The apparatus of claim 1 wherein a longitudinal axis of the separation capillary tube is coaxial with a longitudinal axis of the nozzle outlet.

15. The apparatus of claim 1 wherein the separation capillary tube further comprises a separation capillary tube tapered region proximate to the nozzle outlet.

16. The apparatus of claim 15 further comprising a spacer configured to create a void space between the separation capillary tube and a tapered internal region of the nozzle volume.

17. The apparatus of claim 16 wherein the spacer is integrally formed with the separation capillary tube.

18. The apparatus of claim 1 further comprising:
a sheath liquid reservoir connected with the pump chamber.

19. The apparatus of claim 1 further comprising:
a separation buffer or a sieving matrix in the separation capillary tube;
an analyte within the separation capillary tube; or
a sheath liquid within the pump chamber.

20. The apparatus of claim 1, further comprising:
a first electrode within an inlet of the separation capillary tube; and
a second electrode within the pump chamber or nozzle volume.
